(19) United States
(12) Patent Application Publication
(10) Pub. No.: US 2026/0370087 A1
(43) Pub. Date: Nov. 19, 2026

(54) EXCITER AND ELECTRONIC DEVICE

(71) Applicant: Goertek Inc., Shandong (CN)

(72) Inventors: Yuhang Dong, Shandong (CN); Haiyang Ding, Shandong (CN); Tomokuni Wauke, Shandong (CN)

(73) Assignee: Goertek Inc., Shandong (CN)

(21) Appl. No.: 19/155,305

(22) PCT Filed: Feb. 23, 2024
(86) PCT No.: PCT/CN2024/078298

§ 371 Date: Aug. 11, 2025

(30) Foreign Application Priority Data
Feb. 24, 2023 (CN) 202310182749.1

(51) Int. Cl. H02K 7/06

(52) U.S. Cl. CPC H02K 7/061

(57) ABSTRACT

An exciter includes a housing and two first rotary assemblies. The housing has an installation cavity and a first side wall and an opposing second side wall. The housing is further provided with a first partition connecting the first side wall and the second side wall, for dividing the installation cavity into a first cavity and a second cavity. Two first rotary assemblies are disposed within the first cavity, and the second cavity. Each first rotary assembly includes a first driving member and a first rotating part. The first rotating part is connected to an output end of the first driving member and is arranged eccentrically. The two first driving members synchronously are configured to drive the two first rotating parts to rotate, so that the two first rotating parts simultaneously strike the first partition or simultaneously respectively strike the first and the second side wall.

### CROSS-REFERENCE TO RELATED APPLICATIONS

The present disclosure is a National Stage of International Application No. PCT/CN2024/078298, filed on Feb. 23, 2024, which claims priority to Chinese Patent Application No. 202310182749.1 filed on Feb. 24, 2023, both of which are hereby incorporated by reference in their entireties.

### TECHNICAL FIELD

The present disclosure relates to the technical field of vibration devices, and in particular to an exciter and an electronic device applying said exciter.

### BACKGROUND

Conventional vibration devices generate an illusion of a force seemingly directed in a particular direction by continuously producing asymmetric vibrations, which are also known as anisotropic vibrations.

Currently, there are two methods for generating such a force sensation. One method involves applying an asymmetric signal to a linear resonator and exploiting human perceptual illusions. In principle, this method can only produce a continuous directional force sensation and is incapable of generating discrete vibration outputs. Moreover, the equivalent force perceived through this method is relatively small, and the asymmetric signal induces parasitic vibrations, making it difficult to achieve a clear directional perception. The other method generates a strong force sensation by rapidly braking the linear resonator. This approach produces highly asymmetric vibrations and features a low level of parasitic vibrations, resulting in a distinct and well-isolated force sensation. However, this method requires the vibrating portion and the braking portion to be formed as separate components, and either portion must be continuously moved to switch between energy storage and braking states, thereby preventing high-speed continuous operation and leading to a complex device structure.

Nevertheless, such devices are limited to generating vibrations along a linear direction and are unable to produce a rotational force sensation.

### SUMMARY

The present disclosure aims to provide an exciter and an electronic device, which are designed to generate a rotational directional force sensation. The exciter not only simplifies the structure but also enables high-speed continuous operation, producing a strong and clear force sensation.

To achieve the above objectives, the present disclosure proposes an exciter, which includes:
A housing, having an installation cavity as well as a first side wall and a second side wall opposing each other. The housing is further provided with a first partition connecting the first side wall and the second side wall, the first partition dividing the installation cavity into a first cavity and a second cavity; and
Two first rotary assemblies, one of which is disposed within the first cavity, and the other of which is disposed within the second cavity. Each said first rotary assembly comprises a first driving member and a first rotating part. The first rotating part is connected to an output end of the first driving member and is arranged eccentrically.
The two first driving members synchronously drive the two first rotating parts to rotate, so that the two first rotating parts simultaneously strike the first partition or simultaneously respectively strike the first side wall and the second side wall.

In one embodiment, the first partition is arranged perpendicularly to the first side wall, the first partition is arranged perpendicularly to the second side wall, and the first partition extends between respective midpoints of the first side wall and the second side wall.

In one embodiment, one first driving member is disposed adjacent to the junction between the first side wall and the first partition, and the other first driving member is disposed adjacent to the junction between the second side wall and the first partition, so that the two first driving members are centrally symmetrically arranged.

In one embodiment, it is defined that when the two first rotating parts simultaneously respectively strike the first side wall and the second side wall, the two first rotating parts respectively form a first impact point on the first side wall and a second impact point on the second side wall. The distance from the first impact point to the first partition is equal to the distance from the second impact point to the first partition.

In one embodiment, each first driving member drives the first rotating part to rotate by 90°.

In one embodiment, it is defined that when the first rotating part strikes the first side wall, the second side wall, or the first partition, a first striking place is formed on the respective one of the first side wall, the second side wall, or the first partition. Each first rotary assembly further comprises a first cushioning part. The first cushioning part is disposed on the first side wall and/or the second side wall and/or the first partition, and is located at the first striking place; or, the first cushioning part is disposed on the first rotating part, and when the first driving member drives the first rotating part to rotate, the first cushioning part abuts against the first striking place.

In one embodiment, each first driving member is a rotor motor. The rotor motor is provided with a rotation shaft. Each first rotating part is provided with a shaft hole. The shaft hole is eccentrically arranged on the first rotating part, and the rotation shaft is inserted into the shaft hole. Additionally, or alternatively, the two first rotating parts have equal weight; the two first rotating parts have identical shape contour; the driving frequency of the two first driving members is equal; the driving voltage of the two first driving members is equal.

In one embodiment, each first rotating part comprises at least one mass block, which is made of metal or non-metal.

In one embodiment, the exciter further comprises two second rotary assemblies. One second rotary assembly is disposed within the first cavity and spaced apart from the first rotary assembly in the first cavity. The other second rotary assembly is disposed within the second cavity and spaced apart from the first rotary assembly in the second cavity. Each second rotary assembly comprises a second driving member and a second rotating part. The second rotating part is connected to an output end of the second driving member and arranged eccentrically. The two second driving members synchronously drive the two second rotating parts to rotate, so that the two second rotating parts simultaneously strike the first partition or simultaneously respectively strike the first side wall and the second side wall.

In one embodiment, it is defined that the exciter has a first state and a second state. In the first state, the two first driving members synchronously drive the two first rotating parts to rotate. In the second state, the two second driving members synchronously drive the two second rotating parts to rotate.

In one embodiment, one second driving member is disposed adjacent to the junction between the first side wall and the first partition, and the other second driving member is disposed adjacent to the junction between the second side wall and the first partition, so that the two second driving members are centrally symmetrically arranged.

In one embodiment, the first driving member and the second driving member located within the first cavity are symmetrically arranged with respect to the perpendicular bisector of the first partition. The first driving member and the second driving member located within the second cavity are symmetrically arranged with respect to the perpendicular bisector of the first partition.

In one embodiment, it is defined that when the two second rotating parts simultaneously respectively strike the first side wall and the second side wall, the two second rotating parts respectively form a third impact point on the first side wall and a fourth impact point on the second side wall. The distance from the third impact point to the first partition is equal to the distance from the fourth impact point to the first partition. Additionally, or alternatively, it is defined that when the first rotating part strikes the first side wall, the first rotating part forms a first impact point on the first side wall. When the second rotating part strikes the first side wall, the second rotating part forms a second impact point on the first side wall. The distance from the first impact point to the first partition is equal to the distance from the second impact point to the first partition.

In one embodiment, each second driving member drives the second rotating part to rotate by 90°.

In one embodiment, it is defined that when the second rotating part strikes the first side wall, the second side wall, or the first partition, a second striking place is formed on the respective one of the first side wall, the second side wall, or the first partition. Each second rotary assembly further comprises a second cushioning part. The second cushioning part is disposed on the first side wall and/or the second side wall and/or the first partition, and is located at the second striking place. Or, the second cushioning part is disposed on the second rotating part, and when the second driving member drives the second rotating part to rotate, the second cushioning part abuts against the second striking place.

The present disclosure also proposes an electronic device, which includes a device body having an installation space therein, and the exciter as described above, the exciter being disposed within the installation space.

The exciter of the present disclosure forms an installation cavity within the housing to install and protect the two first rotary assemblies. The housing has a first side wall and a second side wall arranged oppositely. By providing the first partition within the installation cavity of the housing, the first partition connects the first side wall and the second side wall at both ends and divides the installation cavity into a first cavity and a second cavity. Thus, the first cavity and the second cavity can be used to install and fix the two first rotary assemblies respectively. That is, one first rotary assembly is set in the first cavity, and the other first rotary assembly is set in the second cavity. Each first rotary assembly includes a first driving member and a first rotating part. The first rotating part is connected to the output end of the first driving member and is arranged eccentrically. By controlling the two first driving members to synchronously drive the two first rotating parts to rotate, the two first rotating parts can simultaneously strike the first side wall and the second side wall respectively, or the two first rotating parts can simultaneously strike the first partition. This can achieve two extreme state effects. When the two first rotating parts simultaneously strike the first side wall and the second side wall respectively, a torque can be generated in the rotational direction, enabling the exciter to produce a rotational directional force sensation, that is, forming a unidirectional rotational tactile sensation. When the two first rotating parts simultaneously strike the first partition, forces of equal magnitude but opposite directions are generated, which cancel each other out. Meanwhile, by providing the first rotary assembly as a structure in which the first driving member drives the eccentrically arranged first rotating part to rotate, the structure of the exciter is effectively simplified. Moreover, the exciter can achieve high-speed continuous operation and produce a strong and clear force sensation.

### BRIEF DESCRIPTION OF THE DRAWINGS

In order to more clearly illustrate the technical solutions of the embodiments of the present disclosure or of the prior art, the accompanying drawings required for use in the description of the embodiments or of the prior art are briefly introduced below. It is apparent that the drawings described below are merely some embodiments of the present disclosure; for persons of ordinary skill in the art, other drawings can be obtained from the structures shown in these drawings without creative effort.

FIG. 1 is a structural schematic diagram of the exciter in one embodiment of the present disclosure;

FIG. 2 is an exploded view of the first rotary assembly and the second rotary assembly in one embodiment of the present disclosure;

FIG. 3 is a structural schematic diagram of the exciter in the first state in one embodiment of the present disclosure;

FIG. 4 is another structural schematic diagram of the exciter in the first state in one embodiment of the present disclosure;

FIG. 5 is a structural schematic diagram of the exciter in the second state in one embodiment of the present disclosure;

FIG. 6 is another structural schematic diagram of the exciter in the second state in one embodiment of the present disclosure;

FIG. 7 is a test diagram of the exciter in the first state in one embodiment of the present disclosure.

Reference Numerals and Designations

| Numeral | Description | Numeral | Description |
|---|---|---|---|
| 100 | Exciter | 2 | First Rotary Assembly |
| 1 | Housing | 21 | First Driving Member |
| 11 | Installation Cavity | 211 | Rotation Shaft |
| 111 | First Cavity | 22 | First Rotating Part |
| 112 | Second Cavity | 221 | Shaft Hole |
| 12 | First Side Wall | 222 | Mass Block |
| 121 | First Impact Point | 23 | First Cushioning Part |
| 122 | Third Impact Point | 3 | Second Rotary Assembly |
| 13 | Second Side Wall | 31 | Second Driving Member |
| 131 | Second Impact Point | 32 | Second Rotating Part |
| 132 | Fourth Impact Point | 33 | Second Cushioning Part |
| 14 | First Partition | | |

The realization of the objective of the present disclosure, its functional features and advantages will be further explained with reference to the accompanying drawings in conjunction with the embodiments.

### DETAILED DESCRIPTION

In the following description, the technical solutions of the embodiments of the present disclosure will be explained in detail with reference to the accompanying drawings. It should be understood that the embodiments described herein are merely illustrative examples of the present disclosure and are not intended to be exhaustive or limit the disclosure to the specific forms disclosed. All modifications and alternative embodiments that may be devised by persons skilled in the art without departing from the scope of the present disclosure are also encompassed within the protection defined by the appended claims.

It is further noted that, in the embodiments of the present disclosure, directional terms such as “upper,” “lower,” “left,” “right,” “front,” and “back” are used solely for the purpose of describing the relative positional relationships and movement states of the components under a specific orientation (as illustrated in the accompanying drawings). These directional indications may change accordingly when the orientation of the device changes.

Additionally, throughout the present disclosure, the phrase “and/or” encompasses three possible combinations. For example, the phrase “A and/or B” includes: (1) A alone, (2) B alone, and (3) both A and B together.

Furthermore, the use of ordinal terms such as “first,” “second,” etc., in the present disclosure is for descriptive purposes only and should not be construed as indicating relative importance or implying a specific number of the features so described. Therefore, a feature referred to as “first” or “second” may include one or more instances of that feature, either explicitly or implicitly. In addition, the technical solutions of the various embodiments may be combined with each other where such combinations are technically feasible to a person skilled in the art. If a combination of technical features is contradictory or otherwise not realizable, it shall be deemed that such a combination does not exist and is not within the scope of the present disclosure.

Conventional vibration devices generate an illusion of a force seemingly directed in a particular direction by continuously producing asymmetric vibrations, which are also known as anisotropic vibrations.

Currently, there are two methods for generating such a force sensation. One method involves applying an asymmetric signal to a linear resonator and exploiting human perceptual illusions. In principle, this method can only produce a continuous directional force sensation and is incapable of generating discrete vibration outputs. Moreover, the equivalent force perceived through this method is relatively small, and the asymmetric signal induces parasitic vibrations, making it difficult to achieve a clear directional perception. The other method generates a strong force sensation by rapidly braking the linear resonator. This approach produces highly asymmetric vibrations and features a low level of parasitic vibrations, resulting in a distinct and well-isolated force sensation. However, this method requires the vibrating portion and the braking portion to be formed as separate components, and either portion must be continuously moved to switch between energy storage and braking states, thereby preventing high-speed continuous operation and leading to a complex device structure.

Nevertheless, such devices are limited to generating vibrations along a linear direction and are unable to produce a rotational force sensation.

Based on the above concepts and problems, the present disclosure proposes an exciter 100. It can be understood that the exciter 100 is applied to an electronic device. The electronic device may be, without limitation, a tactile display, a tactile interface, a force-feedback device, a vibratory feeder, a beauty product, a personal hygiene product, a personal entertainment product, a personal massager, a feller machine, or a seismic vibrator. For example, a wireless controller for gaming, a motion controller for sports gaming, a wireless steering wheel, or a remote controller for sports gaming in a game console, etc.; no limitation is imposed here.

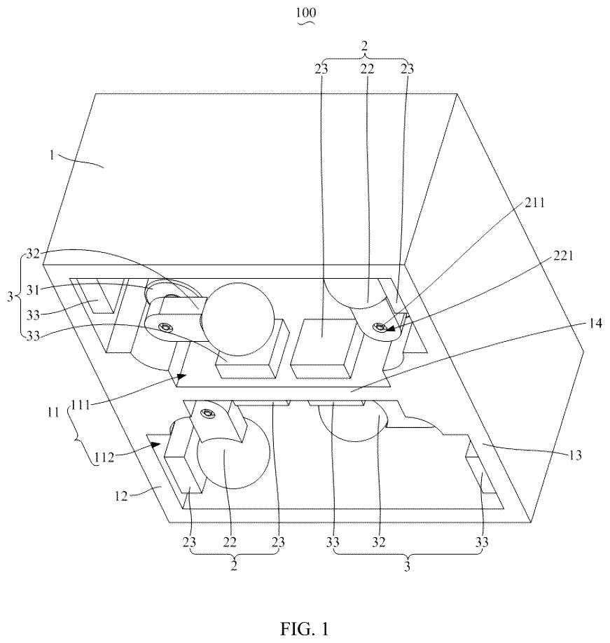

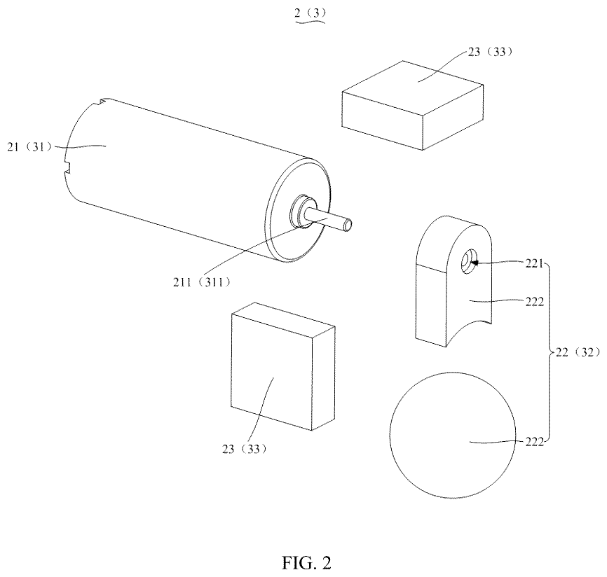

Please refer to FIGS. 1 to 6. In the embodiment of the present disclosure, the exciter 100 includes a housing 1 and two first rotary assemblies 2. The housing 1 has an installation cavity 11 as well as a first side wall 12 and a second side wall 13 opposing each other. The housing 1 is further provided with a first partition 14 connecting the first side wall 12 and the second side wall 13. The first partition 14 divides the installation cavity 11 into a first cavity 111 and a second cavity 112. One first rotary assembly 2 is disposed within the first cavity 111, and the other first rotary assembly 2 is disposed within the second cavity 112. Each first rotary assembly 2 comprises a first driving member 21 and a first rotating part 22. The first rotating part 22 is connected to an output end of the first driving member 21 and is arranged eccentrically. The two first driving members 21 synchronously drive the two first rotating parts 22 to rotate, so that the two first rotating parts 22 simultaneously strike the first partition 14 or simultaneously respectively strike the first side wall 12 and the second side wall 13.

In this embodiment, the housing 1 of the exciter 100 is used to install, fix, and protect the two first rotary assemblies 2 and other components, that is, the housing 1 provides an installation structure for the two first rotary assemblies 2 and other components. It can be understood that the housing 1 can be an installation shell, installation box, or other box-like structures, without limitation. The housing 1 has an installation cavity 11 for placing and installing the two first rotary assemblies 2 and other components. The installation cavity 11 can be a closed cavity, but it can also be an open cavity.

It can be understood that the housing 1 can be an integral structure or a split structure. To facilitate the disassembly and assembly of the two first rotary assemblies 2 and other components, the housing 1 can optionally be split. That is, the housing 1 includes a first shell and a second shell. The first shell and the second shell are docked together and enclose to form the installation cavity 11. It should be noted that the housing 1 can be of a regular shape or an irregular shape, such as regular shapes like circular, elliptical, rectangular, triangular, or other polygonal shapes, or other irregular shapes, without limitation.

In this embodiment, to enable the exciter 100 to generate a rotational directional force sensation, the housing 1 has a first side wall 12 and a second side wall 13 arranged oppositely. The first side wall 12 and the second side wall 13 can be the outer walls of the housing 1, or they can be side walls or partition structures set within the installation cavity 11 of the housing 1, without limitation. By providing the first partition 14 within the installation cavity 11 of the housing 1, the two ends of the first partition 14 respectively connect to the first side wall 12 and the second side wall 13, and divide the installation cavity 11 into a first cavity 111 and a second cavity 112. Thus, the first cavity 111 is used to install and fix one first rotary assembly 2, and the second cavity 112 is used to install and fix the other first rotary assembly 2.

Optionally, the housing 1 is set in a rectangular shape. Further, the housing 1 can be selected as a square or rectangular structure. In this embodiment, the first rotary assembly 2 includes a first driving member 21 and a first rotating part 22. The first driving member 21 is disposed within the first cavity 111/second cavity 112. The first driving member 21 can be directly fixed to the inner wall of the housing 1, or it can be installed within the first cavity 111/second cavity 112 through other structures, such as brackets or mounting seats.

In this embodiment, the first rotating part 22 is connected to the output end of the first driving member 21 and is arranged eccentrically. It can be understood that the first rotating part 22 can be an eccentric structure, or one end of the first rotating part 22 can be connected to the output end of the first driving member 21. When the first driving member 21 drives the first rotating part 22 to rotate, the first rotating part 22 performs a circular motion around the output end of the first driving member 21. That is, the position where the first rotating part 22 is connected to the output end of the first driving member 21 is located at an eccentric position of the first rotating part 22 itself (the position where the first rotating part 22 is connected to the output end of the first driving member 21 does not coincide with the center of the first rotating part 22).

It can be understood that by controlling the two first driving members 21 to synchronously drive the two first rotating parts 22 to rotate, the two first rotating parts 22 can simultaneously strike the first side wall 12 and the second side wall 13, or the two first rotating parts 22 can simultaneously strike the first partition 14. This can achieve two extreme position effects. When the two first rotating parts 22 simultaneously strike the first side wall 12 and the second side wall 13, a torque can be generated in the rotational direction, enabling the exciter 100 to produce a rotational directional force sensation, that is, forming a unidirectional rotational tactile sensation. When the two first rotating parts 22 simultaneously strike the first partition 14, forces of equal magnitude but opposite directions are generated, which cancel each other out. This ensures that the exciter 100 can produce a unidirectional rotational force sensation.

At the same time, by providing the first rotary assembly 2 as a structure in which the first driving member 21 drives the eccentrically arranged first rotating part 22 to rotate, the structure of the exciter 100 is effectively simplified. Moreover, the exciter 100 can achieve high-speed continuous operation and produce a strong and clear force sensation.

It should be noted that the exciter 100 also includes a controller or control structure that can control the two first driving members 21 to drive the two first rotating parts 22 to rotate. It can be understood that the controller or control structure can be a separate controller or remote control, or it can be an integrated control circuit or control button structure on the exciter 100, without limitation.

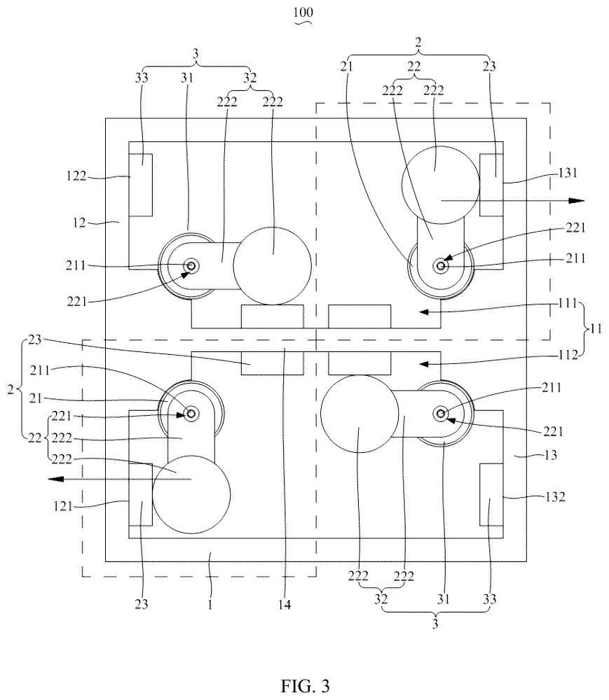

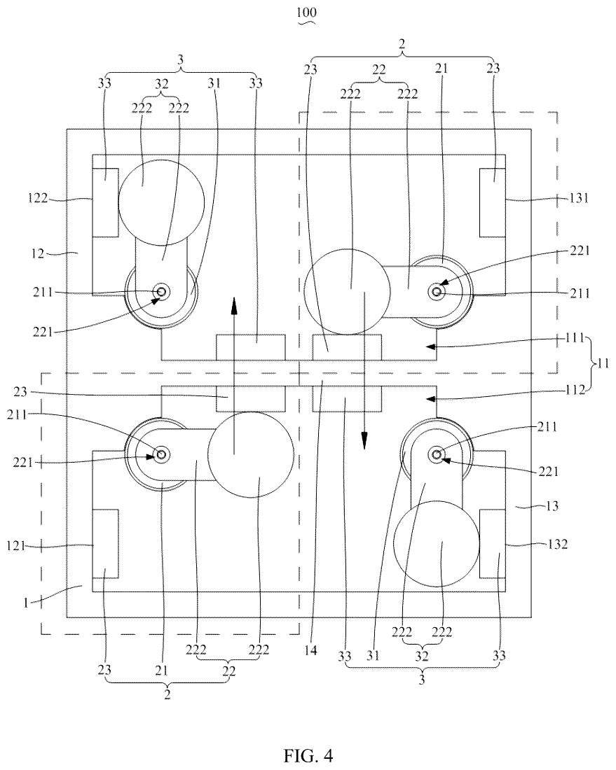

In this embodiment, as shown in FIG. 3, the two first driving members 21 are controlled to rotate in the forward direction to drive the two first rotating parts 22 to rotate clockwise. This causes the two first rotating parts 22 to simultaneously strike the first side wall 12 and the second side wall 13, thereby generating a torque in the clockwise direction, enabling the exciter 100 to produce a force sensation in the clockwise rotational direction. As shown in FIG. 4, the two first driving members 21 are controlled to rotate in the reverse direction to drive the two first rotating parts 22 to rotate counterclockwise. This causes the two first rotating parts 22 to simultaneously strike the first partition 14, thereby generating forces of equal magnitude but opposite direction during counterclockwise rotation, which cancel each other out. This ensures that the exciter 100 can produce a unidirectional force sensation in the clockwise rotational direction.

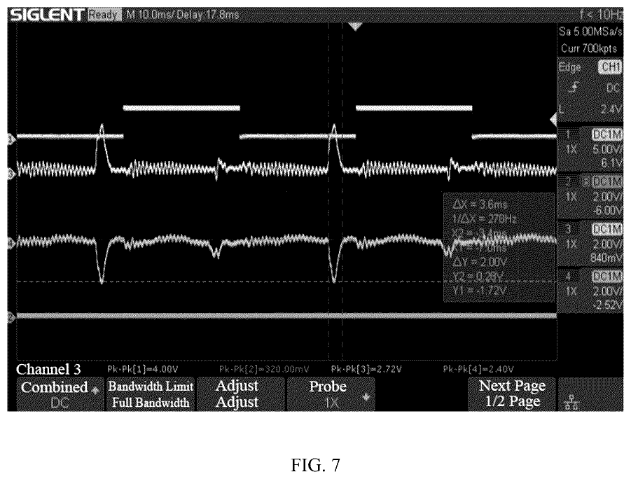

It can be understood that the exciter 100 is defined to have a first state of clockwise rotation. In the first state, the exciter 100 is defined to have a first position where it controls the two first driving members 21 to rotate in the forward direction to drive the two first rotating parts 22 to rotate clockwise, causing the two first rotating parts 22 to simultaneously strike the first side wall 12 and the second side wall 13. It also has a second position where it controls the two first driving members 21 to rotate in the reverse direction to drive the two first rotating parts 22 to rotate counterclockwise, causing the two first rotating parts 22 to simultaneously strike the first partition 14. As shown in FIG. 7, using two accelerometers to detect the vibration of the exciter 100, in the first position of the first state, the housing 1 of the exciter 100 has a noticeable vibration sensation with a clockwise rotational tactile sensation. In the second position of the first state, the housing 1 of the exciter 100 also has a vibration sensation. Since the lever arm at the second position is shorter than that at the first position, the vibration value is relatively lower.

The exciter 100 of the present disclosure forms an installation cavity 11 within the housing 1, thereby utilizing the installation cavity 11 to install, fix, and protect the two first rotary assemblies 2. The housing has a first side wall 12 and a second side wall 13 arranged oppositely. By providing the first partition 14 within the installation cavity 11 of the housing 1, the two ends of the first partition 14 respectively connect to the first side wall 12 and the second side wall 13, and divide the installation cavity 11 into a first cavity 111 and a second cavity 112. Thus, the first cavity 111 and the second cavity 112 can be used to install and fix the two first rotary assemblies 2 respectively, that is, one first rotary assembly 2 is set in the first cavity 111, and the other first rotary assembly 2 is set in the second cavity 112. Each first rotary assembly 2 includes a first driving member 21 and a first rotating part 22, which enables the first rotating part 22 to be connected to the output end of the first driving member 21 and be arranged eccentrically. By controlling the two first driving members 21 to synchronously drive the two first rotating parts 22 to rotate, the two first rotating parts 22 can simultaneously strike the first side wall 12 and the second side wall 13, or the two first rotating parts 22 can simultaneously strike the first partition 14. This can achieve two extreme position effects. When the two first rotating parts 22 simultaneously strike the first side wall 12 and the second side wall 13, a torque can be generated in the rotational direction, enabling the exciter 100 to produce a rotational directional force sensation, that is, forming a unidirectional rotational tactile sensation. When the two first rotating parts 22 simultaneously strike the first partition 14, forces of equal magnitude but opposite directions are generated, which cancel each other out. Meanwhile, by providing the first rotary assembly 2 as a structure in which the first driving member 21 drives the eccentrically arranged first rotating part 22 to rotate, the structure of the exciter 100 is effectively simplified. Moreover, the exciter 100 can achieve high-speed continuous operation and produce a strong and clear force sensation.

In this embodiment, as shown in FIGS. 1 to 6, each first driving member 21 is a rotor motor. The rotor motor is provided with a rotation shaft 211. Each first rotating part 22 is provided with a shaft hole 221. The shaft hole 221 is eccentrically arranged on the first rotating part 22, and the rotation shaft 211 is inserted into the shaft hole 221.

It can be understood that the structure of the first rotating part 22 can be a regular shape or an irregular shape. Optionally, the shape of the first rotating part 22 can be circular, elliptical, rectangular, triangular, or polygonal. The shaft hole 221 does not coincide with the center of the shape of the first rotating part 22. Of course, the shape of the first rotating part 22 can also be an irregular shape, without limitation.

In this embodiment, by providing the first driving member 21 as a rotor motor and utilizing the structure in which the rotor motor drives the eccentrically arranged first rotating part 22 to rotate, the structure of the exciter 100 is effectively simplified. Moreover, the exciter 100 can achieve high-speed continuous operation and produce a strong and clear force sensation.

It should be noted that in order to further ensure that the exciter 100 produces a strong and clear force sensation in a unidirectional rotational direction, the first rotary assembly 2 in the first cavity 111 and the first rotary assembly 2 in the second cavity 112 are centrally symmetrically arranged. Optionally, the two first rotating parts 22 have equal weight and identical shape contours.

It can be understood that in order to further ensure that the exciter 100 produces a strong and clear force sensation in a unidirectional rotational direction, the driving frequency of the two first driving members 21 is the same, and the driving voltage of the two first driving members 21 is the same.

In one embodiment, each first rotating part 22 includes at least one mass block 222. It can be understood that the material of the mass block 222 can be metallic, that is, the mass block 222 is made of metal. Of course, the mass block 222 can also be made of non-metallic material, that is, the mass block 222 is made of non-metal.

It should be noted that in order to enable the exciter 100 to produce a strong and clear force sensation, the mass block 222 of the first rotating part 22 adopts a relatively heavy structure. Optionally, the mass block 222 is made of metal. To further increase the mass of the first rotating part 22, a counterweight or multiple mass blocks 222 can also be provided on the mass block 222 of the first rotating part 22. The counterweight or multiple mass blocks 222 are located in the radial or circumferential direction of the rotation center of the first rotating part 22, and the shaft hole 221 is located at an eccentric position of the overall first rotating part 22 formed (that is, the shaft hole 221 does not coincide with the center of the overall first rotating part 22).

In this embodiment, as shown in FIGS. 1 to 6, the number of mass blocks 222 in the first rotating part 22 can be one, two, three, four, or multiple, without limitation. Among the multiple mass blocks 222, the shaft hole 221 on the mass block 222 connected to the rotation shaft 211 of the first driving member 21 is located at an eccentric position of that mass block 222. At this time, the other mass blocks 222 are connected in the radial or circumferential direction of that mass block 222, and the distance from the other mass blocks 222 to the shaft hole 221 is greater than the distance from the other mass blocks 222 to the center of that mass block 222.

Of course, the shaft hole 221 can also be located at the center of the mass block 222. At this time, the other mass blocks 222 are connected to one side of the mass block 222, so that the overall first rotating part 22 is an eccentric structure, without limitation.

Optionally, each first rotating part 22 includes three mass blocks 222. One mass block 222 is connected to the output end of one first driving member 21 and is arranged eccentrically. The other two mass blocks 222 are connected in sequence along the radial direction of the first rotating part 22; or the other two mass blocks 222 are connected in sequence along the circumferential direction of the mass block 222.

In one embodiment, the first partition 14 is arranged perpendicularly to the first side wall 12, the first partition 14 is arranged perpendicularly to the second side wall 13, and the first partition 14 extends between respective midpoints of the first side wall 12 and the second side wall 13. It can be understood that, as shown in FIGS. 3 to 6, the first side wall 12 and the second side wall 13 of the housing 1 are optionally arranged in parallel. The first cavity 111 and the second cavity 112 of the housing 1 are symmetrically arranged with respect to the first partition 14. At the same time, in order to achieve the same clockwise or counterclockwise rotation of the two first rotating parts 22 of the two first rotary assemblies 2, the first rotary assembly 2 in the first cavity 111 is centrally symmetrically arranged with respect to the first rotary assembly 2 in the second cavity 112.

Optionally, as shown in FIGS. 3 to 6, one first driving member 21 is disposed adjacent to the junction between the first side wall 12 and the first partition 14, and the other first driving member 21 is disposed adjacent to the junction between the second side wall 13 and the first partition 14, so that the two first driving members 21 are centrally symmetrically arranged.

Of course, in other embodiments, the first partition 14 may not be perpendicular to the first side wall 12, and the first partition 14 may not be perpendicular to the second side wall 13. For example, when the first rotating part 22 is set in a sector shape, and the first driving member 21 drives the first rotating part 22 to rotate 90° to collide with the first side wall 12/second side wall 13 or the first partition 14, the first partition 14 may not be perpendicular to the first side wall 12, and the first partition 14 may not be perpendicular to the second side wall 13, without limitation. It can be understood that the first side wall 12/second side wall 13 can be set as a two-section structure with an angle. At this time, the first partition 14 is connected to the angle of the first side wall 12/second side wall 13, and the first partition 14 is not perpendicular to at least one section of the first side wall 12/second side wall 13, without limitation.

In one embodiment, when the two first rotating parts 22 simultaneously strike the first side wall 12 and the second side wall 13 respectively, the two first rotating parts 22 respectively form a first impact point 121 on the first side wall 12 and a second impact point 131 on the second side wall 13. The distance from the first impact point 121 to the first partition 14 is the same as the distance from the second impact point 131 to the first partition 14.

In this embodiment, as shown in FIG. 3, in order to ensure that the distances from the first impact point 121 and the second impact point 131 formed by the two first rotating parts 22 simultaneously striking the first side wall 12 and the second side wall 13 to the first partition 14 are the same, so that the force sensation generated by the exciter 100 in the clockwise rotational direction remains consistent and enhances the user experience, the output end of one first driving member 21 (that is, the rotation center of the first rotating part 22) is located on the bisector of the angle formed by the first side wall 12 and the first partition 14. The output end of the other first driving member 21 (that is, the rotation center of the first rotating part 22) is located on the bisector of the angle formed by the second side wall 13 and the first partition 14.

In one embodiment, the angle of rotation of each first driving member 21 driving the first rotating part 22 can be selected as 90°. When the two first driving members 21 drive the two first rotating parts 22 to rotate in the forward direction, the two first rotating parts 22 simultaneously strike the first side wall 12 and the second side wall 13 respectively. When the two first driving members 21 drive the two first rotating parts 22 to rotate in the reverse direction, the two first rotating parts 22 simultaneously strike the first partition 14.

In this embodiment, as shown in FIGS. 1, 3 to 6, the first side wall 12 and the second side wall 13 of the housing 1 are optionally arranged in parallel. The first partition 14 is perpendicular to the first side wall 12 and the second side wall 13 and extends between respective midpoints of the first side wall 12 and the second side wall 13. One first driving member 21 is disposed adjacent to the junction between the first side wall 12 and the first partition 14, and the other first driving member 21 is disposed adjacent to the junction between the second side wall 13 and the first partition 14. Optionally, one first driving member 21 is located on the diagonal of the angle formed by the first side wall 12 and the first partition 14, and the other first driving member 21 is located on the diagonal of the angle formed by the second side wall 13 and the first partition 14.

It can be understood that the first rotating part 22 is located on the side of the first driving member 21 that is away from the angle formed by the first side wall 12 and the first partition 14 or the angle formed by the second side wall 13 and the first partition 14. This allows the first driving member 21 to drive the first rotating part 22 to rotate by 90°, thereby causing the first rotating part 22 to strike the first side wall 12 or the second side wall 13.

Of course, the angle of rotation of each first driving member 21 driving the first rotating part 22 can also be greater than 900 or less than 90°. It should be noted that when the line connecting the rotation shaft 211 of the first driving member 21 and the center of the first rotating part 22 is not parallel to the first side wall 12/second side wall 13 or the first partition 14, the angle of rotation of the first driving member 21 driving the first rotating part 22 can be greater than 900 or less than 90°. That is, when the two first rotating parts 22 simultaneously strike the first side wall 12 and the second side wall 13, the line connecting the rotation shaft 211 of the first driving member 21 and the center of the first rotating part 22 is not parallel to the first side wall 12/second side wall 13. When the two first rotating parts 22 simultaneously strike the first partition 14, the line connecting the rotation shaft 211 of the first driving member 21 and the center of the first rotating part 22 is not parallel to the first partition 14. In this case, the angle of rotation of the first driving member 21 driving the first rotating part 22 can be greater than 900 or less than 90°, without limitation.

In this embodiment, as shown in FIG. 3, it is defined that the two first driving members 21 drive the two first rotating parts 22 to rotate in the forward direction, that is, the two first driving members 21 rotate in the forward direction, so that when the two first driving members 21 simultaneously drive the two first rotating parts 22 to rotate clockwise, the two first rotating parts 22 simultaneously strike the first side wall 12 and the second side wall 13. As shown in FIG. 4, it is defined that the two first driving members 21 drive the two first rotating parts 22 to rotate in the reverse direction, that is, the two first driving members 21 rotate in the reverse direction, so that when the two first driving members 21 simultaneously drive the two first rotating parts 22 to rotate counterclockwise, the two first rotating parts 22 simultaneously strike the first partition 14.

In one embodiment, it is defined that when the first rotating part 22 strikes the first side wall 12, the second side wall 13, or the first partition 14, a first striking place is formed on the first side wall 12, the second side wall 13, and the first partition 14. Each first rotary assembly 2 further includes a first cushioning part 23. The first cushioning part 23 is disposed on the first side wall 12 and/or the second side wall 13 and/or the first partition 14, and is located at the first striking place. Alternatively, the first cushioning part 23 is disposed on the first rotating part 22, and when the first driving member 21 drives the first rotating part 22 to rotate, the first cushioning part 23 abuts against the first striking place.

In this embodiment, as shown in FIGS. 1 to 6, by providing the first cushioning part 23, the first cushioning part 23 can not only adjust the impact force of the first rotating part 22 but also adjust the sensitive frequency of the vibration wave, making the peak of the wave in FIG. 7 sharper. At the same time, the first cushioning part 23 also has a noise reduction effect.

It can be understood that when the first rotating part 22 strikes the first side wall 12/second side wall 13, the first rotating part 22 forms a first impact point 121/second impact point 131 on the first side wall 12/second side wall 13, and the first impact point 121/second impact point 131 coincides with the first striking place.

In this embodiment, the first cushioning part 23 can be set on the first side wall 12 and/or the second side wall 13 and/or the first partition 14 of the housing 1, and is located at the first striking place. Of course, the first cushioning part 23 can also be set on the first rotating part 22, so that when the first driving member 21 drives the first rotating part 22 to rotate, the first cushioning part 23 abuts against the first striking place.

In this embodiment, the first cushioning part 23 includes multiple ones. The multiple first cushioning parts 23 are respectively set on the first side wall 12, the second side wall 13, and the first partition 14. Alternatively, the multiple first cushioning parts 23 are set on the opposite sides of the first rotating part 22, so that when the first rotating part 22 strikes the first side wall 12/second side wall 13, the first side wall 12/second side wall 13 abuts against the first cushioning part 23, or when the first rotating part 22 strikes the first partition 14, the first partition 14 abuts against the first cushioning part 23, without limitation.

Optionally, the material of the first cushioning part 23 is made of a compressible material, such as foam, sponge, rubber pad, etc., without limitation. That is to say, the first cushioning part 23 does not use rigid material.

In this embodiment, the first driving member 21 is fixedly installed within the first cavity 111/second cavity 112 of the installation cavity 11, and its relative position does not change. The multiple mass blocks 222 of the first rotating part 22 are combined into an overall structure, and the overall structure of the multiple mass blocks 222 moves synchronously as an eccentric mass block.

In one embodiment, the exciter 100 further includes two second rotary assemblies 3. One second rotary assembly 3 is disposed within the first cavity 111 and is spaced apart from the first rotary assembly 2. The other second rotary assembly 3 is disposed within the second cavity 112 and is spaced apart from the first rotary assembly 2. Each second rotary assembly 3 includes a second driving member 31 and a second rotating part 32. The second rotating part 32 is connected to the output end of the second driving member 31 and is arranged eccentrically. The two second driving members 31 synchronously drive the two second rotating parts 32 to rotate, so that the two second rotating parts 32 simultaneously strike the first partition 14 or simultaneously respectively strike the first side wall 12 and the second side wall 13.

In this embodiment, by providing the second rotary assembly 3 in the first cavity 111 and the second cavity 112 of the installation cavity 11 of the housing 1, and spacing the second rotary assembly 3 from the first rotary assembly 2, and providing the second rotary assembly 3 as a structure in which the second rotating part 32 is connected to the output end of the second driving member 31 and is arranged eccentrically, the two second rotating parts 32 can be controlled to simultaneously strike the first side wall 12 and the second side wall 13, or the two second rotating parts 32 can simultaneously strike the first partition 14. This can achieve two extreme position effects. When the two second rotating parts 32 simultaneously strike the first side wall 12 and the second side wall 13, a torque can be generated in the rotational direction, enabling the exciter 100 to produce a rotational directional force sensation, that is, forming a unidirectional rotational tactile sensation. When the two second rotating parts 32 simultaneously strike the first partition 14, forces of equal magnitude but opposite direction are generated, which cancel each other out.

It can be understood that by providing the second rotary assembly 3 as a structure in which the second driving member 31 drives the eccentrically arranged second rotating part 32 to rotate, the structure of the exciter 100 is effectively simplified. Moreover, the exciter 100 can achieve high-speed continuous operation and produce a strong and clear force sensation.

In one embodiment, it is defined that the exciter 100 has a first state of clockwise rotation and a second state of counterclockwise rotation. In the first state, the two first driving members 21 synchronously drive the two first rotating parts 22 to rotate. In the second state, the two second driving members 31 synchronously drive the two second rotating parts 32 to rotate.

It can be understood that when the exciter 100 is in the first state of clockwise rotation, the controller or control structure only controls the two first driving members 21 of the two first rotary assemblies 2 to drive the two first rotating parts 22 to rotate, while the two second driving members 31 of the two second rotary assemblies 3 are in a power-off state. When the exciter 100 is in the second state of counterclockwise rotation, the controller or control structure only controls the two second driving members 31 of the two second rotary assemblies 3 to drive the two second rotating parts 32 to rotate, while the two first driving members 21 of the two first rotary assemblies 2 are in a power-off state.

In this embodiment, in order to ensure that the controller or control structure can control the two first rotary assemblies 2 or the two second rotary assemblies 3 to achieve synchronous movement, in the initial state, the two first rotary assemblies 2 are centrally symmetrically arranged in the first cavity 111 and the second cavity 112, and the two second rotary assemblies 3 are centrally symmetrically arranged in the first cavity 111 and the second cavity 112.

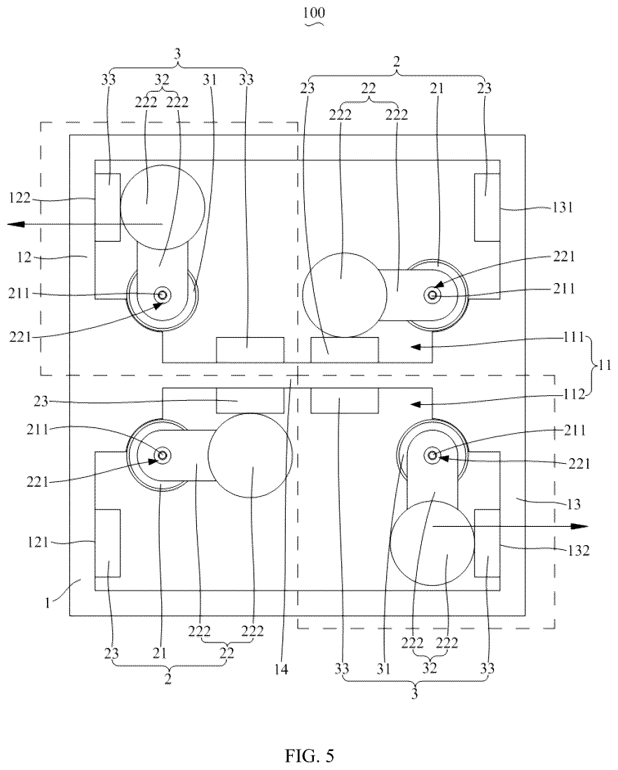

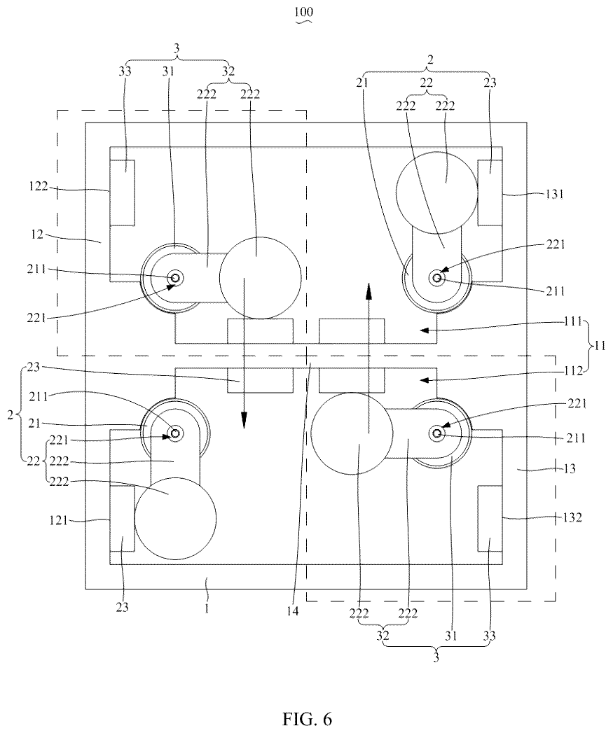

In this embodiment, as shown in FIG. 5, the two second driving members 31 are controlled to rotate in the forward direction to drive the two second rotating parts 32 to rotate counterclockwise, so that the two second rotating parts 32 simultaneously strike the first side wall 12 and the second side wall 13. This generates a torque in the counterclockwise direction, enabling the exciter 100 to produce a force sensation in the counterclockwise rotational direction. As shown in FIG. 6, the two second driving members 31 are controlled to rotate in the reverse direction to drive the two second rotating parts 32 to rotate clockwise, so that the two second rotating parts 32 simultaneously strike the first partition 14. This generates forces of equal magnitude but opposite direction in the clockwise direction, which cancel each other out. This ensures that the exciter 100 can produce a unidirectional force sensation in the counterclockwise rotational direction.

It can be understood that the exciter 100 is defined to have a second state of counterclockwise rotation. In the second state, the exciter 100 is defined to have a first position where it controls the two second driving members 31 to rotate in the forward direction to drive the two second rotating parts 32 to rotate counterclockwise, so that the two second rotating parts 32 simultaneously strike the first side wall 12 and the second side wall 13. It also has a second position where it controls the two second driving members 31 to rotate in the reverse direction to drive the two second rotating parts 32 to rotate clockwise, so that the two second rotating parts 32 simultaneously strike the first partition 14.

Optionally, the structure of the first rotary assembly 2 is the same as that of the second rotary assembly 3. In this embodiment, as shown in FIGS. 1 to 6, each second driving member 31 is a rotor motor. The rotor motor has a rotation shaft 211, and each second rotating part 32 has a shaft hole 221. The shaft hole 221 is eccentrically arranged on the second rotating part 32, and the rotation shaft 211 is inserted into the shaft hole 221.

It can be understood that the structure of the second rotating part 32 can be a regular shape or an irregular shape. Optionally, the shape of the second rotating part 32 can be circular, elliptical, rectangular, triangular, or polygonal. The shaft hole 221 does not coincide with the center of the shape of the second rotating part 32. Of course, the shape of the second rotating part 32 can also be an irregular shape, without limitation.

In this embodiment, by providing the second driving member 31 as a rotor motor and utilizing the structure in which the rotor motor drives the eccentrically arranged second rotating part 32 to rotate, the structure of the exciter 100 is effectively simplified. Moreover, the exciter 100 can achieve high-speed continuous operation and produce a strong and clear force sensation.

It should be noted that in order to further ensure that the exciter 100 produces a strong and clear force sensation in a unidirectional rotational direction, the second rotary assembly 3 in the first cavity 111 and the second rotary assembly 3 in the second cavity 112 are centrally symmetrically arranged. Optionally, the two second rotating parts 32 have equal weight and identical shape contours.

It can be understood that in order to further ensure that the exciter 100 produces a strong and clear force sensation in a unidirectional rotational direction, the driving frequency of the two second driving members 31 is the same, and the driving voltage of the two second driving members 31 is the same.

In one embodiment, each second rotating part 32 includes at least one mass block 222. It can be understood that the material of the mass block 222 can be metallic, that is, the mass block 222 is made of metal. Of course, the mass block 222 can also be made of non-metallic material, that is, the mass block 222 is made of non-metal.

It should be noted that in order to enable the exciter 100 to produce a strong and clear force sensation, the mass block 222 of the second rotating part 32 adopts a relatively heavy structure. Optionally, the mass block 222 is made of metal. To further increase the mass of the second rotating part 32, a counterweight or multiple mass blocks 222 can also be provided on the mass block 222 of the second rotating part 32. The counterweight or multiple mass blocks 222 are located in the radial or circumferential direction of the rotation center of the second rotating part 32, and the shaft hole 221 is located at an eccentric position of the overall second rotating part 32 formed (that is, the shaft hole 221 does not coincide with the center of the overall second rotating part 32).

In this embodiment, as shown in FIGS. 1 to 6, the number of mass blocks 222 in the second rotating part 32 can be one, two, three, four, or multiple, without limitation. Among the multiple mass blocks 222, the shaft hole 221 on the mass block 222 connected to the rotation shaft 211 of the second driving member 31 is located at an eccentric position of that mass block 222. At this time, the other mass blocks 222 are connected in the radial or circumferential direction of that mass block 222, and the distance from the other mass blocks 222 to the shaft hole 221 is greater than the distance from the other mass blocks 222 to the center of that mass block 222.

Of course, the shaft hole 221 can also be located at the center of the mass block 222. At this time, the other mass blocks 222 are connected to one side of the mass block 222, so that the overall second rotating part 32 is an eccentric structure, without limitation.

Optionally, each second rotating part 32 includes three mass blocks 222. One mass block 222 is connected to the output end of one second driving member 31 and is arranged eccentrically. The other two mass blocks 222 are connected in sequence along the radial direction of the second rotating part 32; or the other two mass blocks 222 are connected in sequence along the circumferential direction of the mass block 222.

In one embodiment, as shown in FIGS. 3 to 6, the first partition 14 is arranged perpendicularly to the first side wall 12, the first partition 14 is arranged perpendicularly to the second side wall 13, and the first partition 14 extends between respective midpoints of the first side wall 12 and the second side wall 13.

It can be understood that, as shown in FIGS. 3 to 6, the first side wall 12 and the second side wall 13 of the housing 1 are optionally arranged in parallel. The first cavity 111 and the second cavity 112 of the housing 1 are symmetrically arranged with respect to the first partition 14. At the same time, in order to achieve the same clockwise or counterclockwise rotation of the two second rotating parts 32 of the two second rotary assemblies 3, the second rotary assembly 3 in the first cavity 111 is centrally symmetrically arranged with respect to the second rotary assembly 3 in the second cavity 112.

Optionally, as shown in FIGS. 3 to 6, one second driving member 31 is disposed adjacent to the junction between the first side wall 12 and the first partition 14, and the other second driving member 31 is disposed adjacent to the junction between the second side wall 13 and the first partition 14, so that the two second driving members 31 are centrally symmetrically arranged.

Optionally, the first driving member 21 and the second driving member 31 located within the first cavity 111 are symmetrically arranged with respect to the perpendicular bisector of the first partition 14. The first driving member 21 and the second driving member 31 located within the second cavity 112 are symmetrically arranged with respect to the perpendicular bisector of the first partition 14.

In one embodiment, when the two second rotating parts 32 simultaneously strike the first side wall 12 and the second side wall 13 respectively, the two second rotating parts 32 respectively form a third impact point 122 on the first side wall 12 and a fourth impact point 132 on the second side wall 13. The distance from the third impact point 122 to the first partition 14 is the same as the distance from the fourth impact point 132 to the first partition 14.

In this embodiment, as shown in FIG. 5, in order to ensure that the distances from the third impact point 122 and the fourth impact point 132 formed by the two second rotating parts 32 simultaneously striking the first side wall 12 and the second side wall 13 to the first partition 14 are the same, so that the force sensation generated by the exciter 100 in the counterclockwise rotational direction remains consistent and enhances the user experience, the output end of one second driving member 31 (that is, the rotation center of the second rotating part 32) is located on the bisector of the angle formed by the first side wall 12 and the first partition 14. The output end of the other second driving member 31 (that is, the rotation center of the second rotating part 32) is located on the bisector of the angle formed by the second side wall 13 and the first partition 14.

In one embodiment, as shown in FIGS. 3 to 6, when the first rotating part 22 strikes the first side wall 12, the first rotating part 22 forms a first impact point on the first side wall 12. When the second rotating part 32 strikes the first side wall 12, the second rotating part 32 forms a second impact point on the first side wall 12. The distance from the first impact point to the first partition 14 is the same as the distance from the second impact point to the first partition 14.

It can be understood that the shape contour of the first rotating part 22 is the same as that of the second rotating part 32, that is, the structure of the first rotary assembly 2 is the same as that of the second rotary assembly 3.

In one embodiment, the angle of rotation of each second driving member 31 driving the second rotating part 32 is 90°. When the two second driving members 31 drive the two second rotating parts 32 to rotate in the forward direction, the two second rotating parts 32 simultaneously strike the first side wall 12 and the second side wall 13 respectively. When the two second driving members 31 drive the two second rotating parts 32 to rotate in the reverse direction, the two second rotating parts 32 simultaneously strike the first partition 14.

In this embodiment, as shown in FIGS. 1, 3 to 6, the first side wall 12 and the second side wall 13 of the housing 1 are optionally arranged in parallel. The first partition 14 is perpendicular to the first side wall 12 and the second side wall 13 and is located at the middle position between the first side wall 12 and the second side wall 13. One second driving member 31 is disposed adjacent to the junction between the first side wall 12 and the first partition 14, and the other second driving member 31 is disposed adjacent to the junction between the second side wall 13 and the first partition 14. Optionally, one second driving member 31 is located on the diagonal of the angle formed by the first side wall 12 and the first partition 14, and the other second driving member 31 is located on the diagonal of the angle formed by the second side wall 13 and the first partition 14.

It can be understood that the second rotating part 32 is located on the side of the second driving member 31 that is away from the angle formed by the first side wall 12 and the first partition 14 or the angle formed by the second side wall 13 and the first partition 14. This allows the second driving member 31 to drive the second rotating part 32 to rotate by 90°, thereby causing the second rotating part 32 to strike the first side wall 12 or the second side wall 13.

Of course, the angle of rotation of each second driving member 31 driving the second rotating part 32 can also be greater than 90° or less than 90°. It should be noted that when the line connecting the rotation shaft 211 of the second driving member 31 and the center of the second rotating part 32 is not parallel to the first side wall 12/second side wall 13 or the first partition 14, the angle of rotation of the second driving member 31 driving the second rotating part 32 can be greater than 90° or less than 90°. That is, when the two second rotating parts 32 simultaneously strike the first side wall 12 and the second side wall 13, the line connecting the rotation shaft 211 of the second driving member 31 and the center of the second rotating part 32 is not parallel to the first side wall 12/second side wall 13. When the two second rotating parts 32 simultaneously strike the first partition 14, the line connecting the rotation shaft 211 of the second driving member 31 and the center of the second rotating part 32 is not parallel to the first partition 14. In this case, the angle of rotation of the second driving member 31 driving the second rotating part 32 can be greater than 90° or less than 90°, without limitation.

In this embodiment, as shown in FIG. 5, it is defined that the two second driving members 31 drive the two second rotating parts 32 to rotate in the forward direction, that is, the two second driving members 31 rotate in the forward direction, so that when the two second driving members 31 simultaneously drive the two second rotating parts 32 to rotate counterclockwise, the two second rotating parts 32 simultaneously strike the first side wall 12 and the second side wall 13 respectively. As shown in FIG. 6, it is defined that the two second driving members 31 drive the two second rotating parts 32 to rotate in the reverse direction, that is, the two second driving members 31 rotate in the reverse direction, so that when the two second driving members 31 simultaneously drive the two second rotating parts 32 to rotate clockwise, the two second rotating parts 32 simultaneously strike the first partition 14.

In one embodiment, it is defined that when the second rotating part 32 strikes the first side wall 12, the second side wall 13, or the first partition 14, a second striking place is formed on the first side wall 12, the second side wall 13, and the first partition 14. Each second rotary assembly 3 further includes a second cushioning part 33. The second cushioning part 33 is disposed on the first side wall 12 and/or the second side wall 13 and/or the first partition 14, and is located at the second striking place. Alternatively, the second cushioning part 33 is disposed on the second rotating part 32, and when the second driving member 31 drives the second rotating part 32 to rotate, the second cushioning part 33 abuts against the second striking place.

In this embodiment, as shown in FIGS. 1 to 6, by providing the second cushioning part 33, the second cushioning part 33 can not only adjust the impact force of the second rotating part 32 but also adjust the sensitive frequency of the vibration wave, making the peak of the wave in FIG. 7 sharper. At the same time, the second cushioning part 33 also has a noise reduction effect.

It can be understood that when the second rotating part 32 strikes the first side wall 12/second side wall 13, the second rotating part 32 forms a third impact point 122/fourth impact point 132 on the first side wall 12/second side wall 13, and the third impact point 122/fourth impact point 132 coincides with the second striking place.

In this embodiment, the second cushioning part 33 can be set on the first side wall 12 and/or the second side wall 13 and/or the first partition 14 of the housing 1, and is located at the first striking place. Of course, the second cushioning part 33 can also be set on the second rotating part 32, so that when the second driving member 31 drives the second rotating part 32 to rotate, the second cushioning part 33 abuts against the second striking place.

In this embodiment, the second cushioning part 33 includes multiple ones. The multiple second cushioning parts 33 are respectively set on the first side wall 12, the second side wall 13, and the first partition 14. Alternatively, the multiple second cushioning parts 33 are set on the opposite sides of the second rotating part 32, so that when the second rotating part 32 strikes the first side wall 12/second side wall 13, the first side wall 12/second side wall 13 abuts against the second cushioning part 33, or when the second rotating part 32 strikes the first partition 14, the first partition 14 abuts against the second cushioning part 33, without limitation.

Optionally, the material of the second cushioning part 33 is made of a compressible material, such as foam, sponge, rubber pad, etc., without limitation. That is to say, the second cushioning part 33 does not use rigid material.

In this embodiment, the second driving member 31 is fixedly installed within the first cavity 111/second cavity 112 of the installation cavity 11, and its relative position does not change. The multiple mass blocks 222 of the second rotating part 32 are combined into an overall structure, and the overall structure of the multiple mass blocks 222 moves synchronously as an eccentric mass block.

It can be understood that when the rotor motor is driven, the first rotating part 22/second rotating part 32 generates rapid rotation around the rotation shaft 211 of the rotor motor. When the first rotating part 22/second rotating part 32 moves to the two extreme positions, it collides with the corresponding first side wall 12 and second side wall 13 of the housing 1. When the first rotating part 22/second rotating part 32 collides with the housing 1, a rapid braking effect is produced, and the corresponding impact tactile sensation is received on the housing 1. By driving multiple rotor motors in combination, two extreme state effects can be achieved, that is, one side has a unidirectional rotational tactile sensation, and the other side also has a rotational tactile sensation in the same direction. The magnitude of the rotational tactile sensation on both sides is related to the product of the corresponding force and the lever arm. Furthermore, by using long-term, high-frequency driving to produce rapid, multi-frequency unidirectional rotational tactile sensations on the same coordinate axis, that is, clockwise rotational tactile sensation and counterclockwise rotational tactile sensation.

It should be noted that when the first rotating part 22/second rotating part 32 moves to the extreme position, the impact forces of the two first rotating parts 22/two second rotating parts 32 on the housing 1 are parallel and have equal lever arms, thereby achieving the effect of pure rotational tactile sensation.

Of course, in actual use, both extremes of the same rotation can be fully utilized, or one group of lever arms can be made longer according to the structural division, thereby obtaining better tactile feedback, without limitation.

The present disclosure also proposes an electronic device, which includes a device body and the aforementioned exciter 100. The device body has an installation space, and the exciter 100 is disposed within the installation space. The specific structure of the exciter 100 refers to the foregoing embodiments. Since this electronic device adopts all the technical solutions of the foregoing embodiments, it therefore has at least all the beneficial effects brought by the technical solutions of the foregoing embodiments, which will not be repeated one by one here.

The above description is only an optional embodiment of the present disclosure and does not limit the scope of the patent of the present disclosure. Any equivalent structural transformation made based on the description and drawings of the present disclosure, or any direct or indirect applications thereof in other related technical fields, shall fall within the scope of patent protection of the present disclosure.

1. An exciter, comprising
a housing having
an installation cavity,
a first side wall and an opposing second side wall, and
a first partition connecting the first side wall and the second side wall,
wherein the first partition dividing the installation cavity into a first cavity and a second cavity; and
two first rotary assemblies, disposed within the first cavity and the second cavity respectively, each first rotary assembly comprising a first driving member and a first rotating part, wherein the first rotating part is connected to an output end of the first driving member and is arranged eccentrically;
wherein the two first driving members synchronously are configured to drive the two first rotating parts to rotate, so that the two first rotating parts simultaneously strike the first partition or simultaneously respectively strike the first side wall and the second side wall.

2. The exciter according to claim 1, wherein the first partition is arranged perpendicularly to the first side wall, the first partition is arranged perpendicularly to the second side wall, and the first partition extends centrally between the first side wall and the second side wall.

3. The exciter according to claim 2, wherein the two first driving members are respectively disposed adjacent to a first junction between the first side wall and the first partition and disposed adjacent a second junction between the second side wall and the first partition, so that the two first driving members are centrally symmetrically arranged.

4. The exciter according to claim 2, wherein when the two first rotating parts simultaneously respectively strike the first side wall and the second side wall, the two first rotating parts respectively form a first impact point on the first side wall and a second impact point on the second side wall, a distance from the first impact point to the first partition is equal to a distance from the second impact point to the first partition.

5. The exciter according to claim 1, wherein each first driving member is configured to drive the first rotating part to rotate by 90°.

6. The exciter according to claim 1, wherein when the first rotating part strikes the first side wall, the second side wall, or the first partition to form a first striking place thereon, each first rotary assembly further comprising a first cushioning part;
the first cushioning part is disposed on at least one of the first side wall, the second side wall, and the first partition, and is located at the first striking place; or, the first cushioning part is disposed on the first rotating part, and when the first driving member drives the first rotating part to rotate, the first cushioning part abuts against the first striking place.

7. The exciter according to claim 1, wherein each first driving member comprises a rotor motor, the rotor motor being provided with a rotation shaft, each first rotating part being provided with a shaft hole, the shaft hole being eccentrically arranged on the first rotating part, the rotation shaft being inserted into the shaft hole;
and/or, the two first rotating parts have equal weight;
and/or, the two first rotating parts have identical shape contours;
and/or, two first driving members have equal driving frequency;
and/or, the two first driving members have equal driving voltaage.

8. The exciter according to claim 1, wherein each first rotating part comprises at least one mass block,
wherein the mass block is make of metal or non-metal.

9. The exciter according to claim 1, further comprises two second rotary assemblies, respectively disposed within the first cavity and spaced apart from the first rotary assembly, in the first cavity, and disposed within the second cavity and spaced apart from the first rotary assembly in the second cavity, each second rotary assembly comprising a second driving member and a second rotating part connected to an output end of the second driving member and arranged eccentrically;
wherein, the two second driving members synchronously are configured to drive the two second rotating parts to rotate, so that the two second rotating parts simultaneously strike the first partition or simultaneously respectively strike the first side wall and the second side wall.

10. The exciter according to claim 9, wherein the exciter has a first state and a second state;
wherein in the first state, the two first driving members synchronously drive the two first rotating parts to rotate; and
in the second state, the two second driving members synchronously drive the two second rotating parts to rotate.

11. The exciter according to claim 9, wherein the two second driving member are respectively disposed adjacent to a junction between the first side wall and the first partition, and disposed adjacent to a junction between the second side wall and the first partition, so that the two second driving members are centrally symmetrically arranged.

12. The exciter according to claim 11, wherein the first driving member and the second driving member located within the first cavity are symmetrically arranged with respect to a perpendicular bisector of the first partition;
the first driving member and the second driving member located within the second cavity are symmetrically arranged with respect to the perpendicular bisector of the first partition.

13. The exciter according to claim 9, wherein when the two second rotating parts simultaneously respectively strike the first side wall and the second side wall, the two second rotating parts respectively form a third impact point on the first side wall and a fourth impact point on the second side wall, a distance from the third impact point to the first partition is equal to a distance from the fourth impact point to the first partition;
and/or, when the first rotating part strikes the first side wall, the first rotating part forms a first impact point on the first side wall, and when the second rotating part strikes the first side wall, the second rotating part forms a second impact point on the first side wall, a distance from the first impact point to the first partition is equal to a distance from the second impact point to the first partition.

14. The exciter according to claim 9, wherein each second driving member is configured to drive the second rotating part to rotate by 90°.

15. The exciter according to claim 9, wherein when the second rotating part strikes at least one of the first side wall, the second side wall, or the first partition to form a second striking place thereon, each second rotary assembly further comprising a second cushioning part;
the second cushioning part is disposed on at least one of the first side wall, the second side wall, the first partition, and is located at the second striking place; or, the second cushioning part is disposed on the second rotating part, and when the second driving member drives the second rotating part to rotate, the second cushioning part abuts against the second striking place.

16. An electronic device, comprising
a device body having an installation space therein; and
the exciter according to claim 1, the exciter being disposed within the installation space.
